(19) United States
(12) Patent Application Publication
(10) Pub. No.: US 2025/0151870 A1
(43) Pub. Date: May 15, 2025

(54) HAIRCARE APPLIANCE

(71) Applicant: Dyson Technology Limited, Malmesbury, Wiltshire (GB)

(72) Inventor: Chaoying FANG, Tetbury (GB)

(21) Appl. No.: 18/839,494

(22) PCT Filed: Jan. 27, 2023
(86) PCT No.: PCT/GB2023/050181

§ 371 Date: Aug. 19, 2024

(30) Foreign Application Priority Data
Feb. 21, 2022 (GB) 2202275.0

(51) Int. Cl. A45D 6/20; A45D 2/00

(52) U.S. Cl. CPC A45D 6/20; A45D 2/001

(57) ABSTRACT

A haircare appliance is described comprising a heater assembly and a controller. The heater assembly comprises a heating element and a sensor to sense a temperature of the heater assembly. The controller is configured to determine the presence or absence of hair in contact with the heater assembly based on the sensed temperature.

### FIELD OF THE INVENTION

The present invention relates to a haircare appliance.

### BACKGROUND OF THE INVENTION

A haircare appliance may utilise a pair of plates to style the hair of a user. In use, a tress of hair may be clamped between the plates, and the appliance drawn along the length of the tress. This process may then be repeated to style a full head of hair.

### SUMMARY OF THE INVENTION

The present invention provides a haircare appliance comprising: a heater assembly comprising a heating element and a sensor to sense a temperature of the heater assembly; and a controller configured to determine the presence or absence of hair in contact with the heater assembly based on the sensed temperature.

The haircare appliance therefore has an awareness of whether or not hair is present or absent and therefore whether heating is required for styling. Advantageously, this awareness may be used to improve the functionality of the haircare appliance. For example, the temperature of the heater assembly may be increased when hair is present and decreased when hair is absent. Furthermore, determining the presence or absence of hair based on the temperature of the heater assembly may provide a relatively inexpensive and robust approach for determining the presence or absence of hair due to the relatively low cost and complexity of a temperature sensor.

The controller may be configured to compare the sensed temperature against a setpoint and determine the presence or absence of hair in contact with the heater assembly based on the comparison. The presence of hair typically lowers the temperature of the heater assembly for a given input power. Conversely, when hair is removed, the temperature of the heater assembly will increase, again for a given input power. This behaviour can therefore be used to determine the presence or absence of hair by comparing the sensed temperature against the setpoint. For example, if the sensed temperature drops below the setpoint, or if the difference between the sensed temperature and the setpoint is excessive, this may suggest that hair is present. Conversely, if the sensed temperature rises above the setpoint, or if the difference between the sensed temperature and the setpoint is excessive, this may suggest that hair is no longer present.

The controller may be configured to vary the setpoint. This may have the advantage of enabling dynamic or variable temperature control. For example, the haircare appliance may employ a lower temperature at the roots of the hair and gradually increase the temperature as the haircare appliance is moved towards the tips of the hair. This root-to-tip heating may reduce damage to the hair by using a lower temperature at the roots where the hair is younger, and a higher temperature at the tips where the hair is older. Additionally, by comparing the sensed temperature to the setpoint, the presence or absence of hair may continue to be determined even as the setpoint is changed. For example, during root-to-tip heating.

The controller may be configured to control a supply of electrical power to the heating element based on the determination. As a result, the functionality of the haircare appliance may be improved as the temperature of the heating element may be changed depending on whether or not hair is present or absent.

The controller may be configured to increase the supply of electrical power to the heating element to increase the temperature of the heating element in response to determining the presence of hair in contact with the heater assembly or to decrease the supply of electrical power to the heating element to decrease the temperature of the heating element in response to determining the absence of hair in contact with the heater assembly. This may result in several benefits. Firstly, this may improve the energy efficiency of the haircare appliance. Secondly, this may increase the operational life of the haircare appliance by reducing the amount of time the heater assembly is required to operate at the higher temperature required for hair styling.

The controller may be configured to control the supply of electrical power to the heating element to maintain the temperature of the heating element at a setpoint and increase the setpoint in response to determining the presence of hair in contact with the heater assembly or decrease the setpoint in response to determining the absence of hair in contact with the heater assembly. By increasing or decreasing the setpoint in response to determining the presence or absence of hair, the heating element may operate at a lower temperature when hair is absent to thereby reduce energy consumption and thus improve the efficiency and longevity of the haircare appliance.

The controller may be configured to increase the setpoint from a first value to a second value in response to determining the presence of hair in contact with the heater assembly and decrease the setpoint from the second value to the first value in response to determining the absence of hair in contact with the heater assembly. Thereby, the heater assembly may respond to the arrival of hair by operating at a higher setpoint temperature (second value) to style the hair, and respond to the subsequent departure of the hair by operating at a lower setpoint temperature (first value) to reduce the energy consumption of the heater assembly.

The heater assembly may comprise a contact member having a plurality of zones, a plurality of heating elements, and a plurality of sensors. Each heating element may heat a respective zone of the contact member, and each sensor may sense a temperature of a respective zone. The controller may be configured to determine the presence or absence of hair in contact with each of the zones of the contact member based on the sensed temperatures and control a supply of electrical power to each of the heating elements based on the determination. As a result, the heater assembly is able to respond to uneven distributions of hair over the heater assembly. For example, the heater assembly may respond differently in zones where hair is present compared to zones where hair is absent.

In response to determining the presence of hair in contact with one or more of the zones of the contact member, the controller may be configured to increase the supply of electrical power to only those heating elements of the zones for which the presence of hair is determined. As a result, the energy consumption of the heater assembly may be reduced without adversely impacting heating of the hair.

The controller may be configured to control the supply of electrical power to each of the heating elements to maintain the temperature of each of the heating elements at a respective setpoint and increase the setpoint for only those heating elements of the zones for which the presence of hair is determined. As a result, the temperature of only those zones in contact with hair is increased. Those zones that are not in contact with hair may operate at a lower temperature to thereby reduce energy consumption and improve the efficiency and longevity of the haircare appliance. Additionally, those zones that are not increased in temperature may act as heat sinks for adjacent zone that are increased in temperature. This may then prevent hair damage caused by localised overheating that may result from incomplete hair coverage of a zone.

For only those heating elements of the zones for which the presence of hair is determined, the controller may be configured to increase the setpoint from a first value to a second value and decrease the setpoint from the second value to the first value for only those heating elements of the zones for which the subsequent absence of hair is determined. Thereby, the heater assembly may respond to the arrival of hair on a zone by operating the heating element for that zone at a higher temperature and respond to the subsequent departure of the hair from the zone by operating the heating element for that zone at a lower temperature. As a result, the energy consumption of the heater assembly may be reduced without adversely affecting heating and styling of the hair.

In response to determining the presence of hair in contact with one or more of the zones of the contact member, the controller may be configured to decrease or maintain the supply of electrical power to those heating elements of the zones for which the absence of hair is determined. By maintaining the supply of electrical power, the zones may be maintained at a temperature ready for the next pass. Thereby, energy consumption may be reduced without adversely affecting the responsiveness of the heater assembly. By decreasing the electrical power when hair is detected for some, but not all, of the zones, further reductions in energy consumption can be achieved without adversely affecting styling results.

The controller may be configured to control the supply of electrical power to each of the heating elements to maintain the temperature of each of the heating elements at a respective setpoint, and to decrease the setpoint for each of those heating elements which heat a zone for which the absence of hair is determined. As noted above, by maintaining the temperature at a respective setpoint, energy consumption may be reduced without adversely affecting the responsiveness of the heater assembly. Furthermore, by decreasing the setpoint, further reductions in energy consumption can be achieved without adversely affecting styling results.

The controller may be configured to determine the presence and the absence of hair in contact with the heater assembly based on the sensed temperature and to determine a duration between determining the presence of hair and determining the subsequent absence of hair. As a result, the controller is able to determine the time taken for a user to pass a tress of hair through the haircare appliance. The controller may then use this duration to provide additional functionality. For example, the controller may provide feedback to the user based on the duration, e.g. an alert that the speed of the haircare appliance along the tress was too fast or too slow.

In response to determining the presence of hair in contact with the heater assembly, the controller may be configured to increase the supply of electrical power to the heating element to increase the temperature of the heating element at a rate based on the determined duration. This may enable the heater assembly to employ the root-to-tip heating discussed previously. By using a rate based on the determined duration, the haircare appliance may tailor the root-to-tip heating to a specific user behaviour to achieve a desired temperature increase between root and tip. As noted above, this root-to-tip heating may reduce damage to the hair by using a lower temperature at the root where the hair is younger, and a higher temperature at the tip where the hair is older.

The controller may be configured to compare a parameter against a threshold, and to determine the presence or absence of hair in contact with the heater assembly based on the comparison. The parameter may be one of: the sensed temperature; a difference between the sensed temperature and a setpoint; a magnitude of electrical power supplied to the heating element; and a control variable for use in controlling a supply of electrical power to the heating element, wherein the control variable varies as a function of the sensed temperature. As discussed previously, the presence of hair typically lowers the temperature of the heater assembly for a given input power. Conversely, when hair is removed, the temperature of the heater assembly may increase, again for a given input power. This behaviour can then be used to determine the presence or absence of hair by comparing the parameter against the threshold. For example, if the sensed temperature drops below a threshold, or if the absolute difference between the sensed temperature and the setpoint exceeds a threshold this may suggest that hair is present. Conversely, if the sensed temperature rises above a threshold, or if the absolute difference between the sensed temperature and the setpoint exceeds the threshold, this may suggest that hair is no longer present. In another example, where the power supplied to the heating element is controlled so as to maintain the heating element at a particular temperature, an increase or a decrease in the supplied power, or an increase or decrease in a control variable used to control the supplied power may be indicative of the presence or absence of hair respectively. The controller may be configured to determine the presence of hair in contact with the heater assembly based on the parameter traversing a first threshold; and determine the subsequent absence of hair in contact with the heater assembly based on the parameter traversing a second threshold.

The present invention also provides a method comprising sensing a temperature of a heater assembly of a haircare appliance; and determining the presence or absence of hair in contact with the heater assembly based on the sensed temperature.

### BRIEF DESCRIPTION OF THE DRAWINGS

FIG. 1 is a side view of a haircare appliance with arms of the haircare appliance in an open position;

FIG. 2 is a perspective view of the haircare appliance with the arms in a closed position;

FIG. 3 is a partially exploded view of the haircare appliance;

FIG. 4 is an exploded view of a heater assembly of the haircare appliance;

FIG. 5 is a block diagram of electrical components of the haircare appliance;

FIG. 6 shows an example method for determining the presence or absence of hair in contact with a heater assembly;

FIG. 7 shows an example method for determining the presence or absence of hair in contact with a heater assembly based on a sensed temperature;

FIG. 8 shows an example method of using a determination of the presence or absence of hair to implement dynamic or variable temperature control of the heating element;

FIG. 9 illustrates the behaviour of a setpoint value when employing the method of FIG. 8;

FIG. 10 illustrates the behaviour of a setpoint value when employing an alternative method; and

FIG. 11 is an exploded view of an alternative heater assembly.

### DETAILED DESCRIPTION OF THE INVENTION

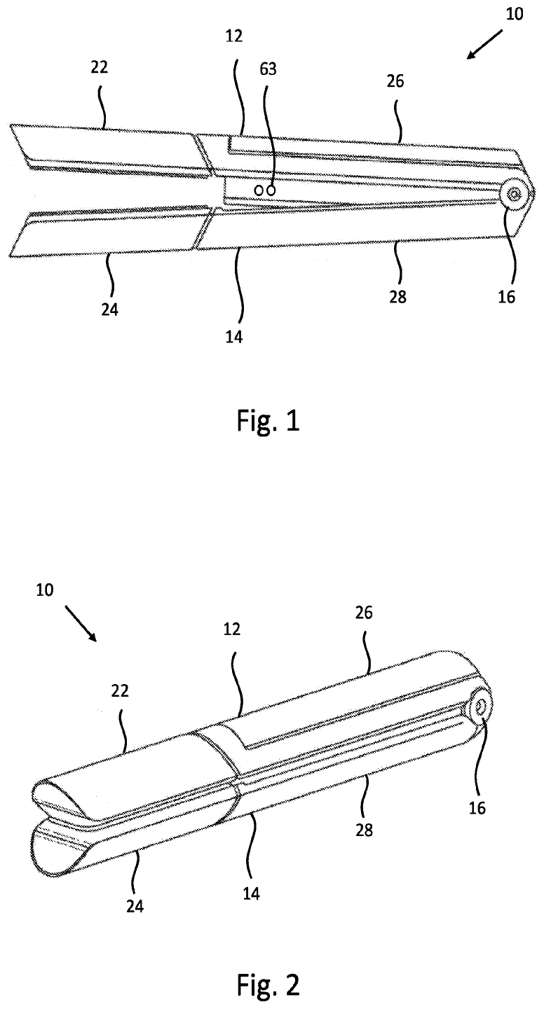

The haircare appliance 10 of FIGS. 1 and 2 comprises a first arm 12 and a second arm 14 pivotably connected at one end by a hinge 16. The arms 12,14 are moveable about the hinge between an open position (shown in FIG. 1) and a closed position (shown in FIG. 2). The haircare appliance 10 may take the general form of a hair straightener.

Each arm 12,14 comprises a heating section 22,24 located at an end of each arm 12,14 remote from the hinge 16, and a handle section 26,28 located at an opposite end of each arm 12,14 where the hinge 16 is located. In use, the user grips the handle sections 26,28 and inserts a section of hair between the two arms 12,14. The user then applies pressure to the handle sections 26,28 in order to close the arms 12,14. In closing the arms 12,14, the hair is gripped between the heating sections 22,24. The arms 12,14 are biased towards the open position such that when the user releases the pressure on the handle sections 26,28, the arms 12,14 return to the open position.

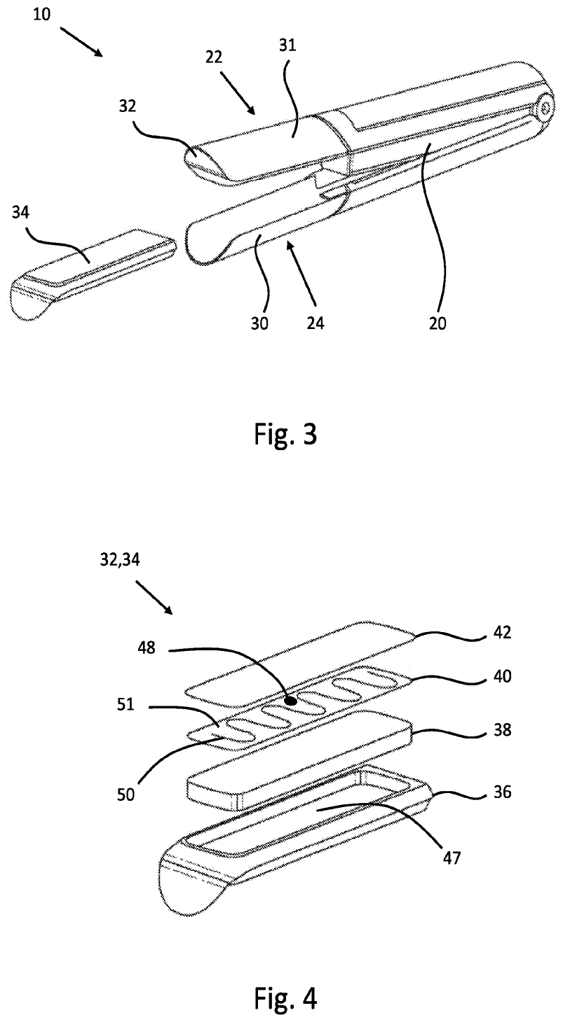

Referring now to FIGS. 3 and 4, the heating section 22,24 of each arm 12,14 comprises a casing 30,31 within which a heater assembly 32,34 is located. Each of the heater assemblies 32,34 comprises multiple layers of components arranged in a stack. Each heater assembly 32,34 comprises, in order from the bottom to the top of the stack, a housing 36, a support member 38, a sensor and heating element layer 40 and a contact member 42.

The housing 36 is located at the bottom of the stack and comprises a recess 47 for receiving the other components 38,40,42 of the heater assembly 32,34.

The support member 38 is located within the recess 47 of the housing 36 and supports the sensor and heating element layer 40 and the contact member 42. In examples, the support member 38 may be made from a flexible material such that the sensor and heating element layer 40 and the contact member 42 are free to deform when contacting hair. As a result, a corralling effect, where hair is gathered and shaped, may be provided, which may result in improved hair styling.

The sensor and heating element layer 40 is located on top of the support member 38 and within the recess 47. The sensor and heating element layer 40 comprises a sensor 48 and a heating element 50 located on a substrate 51. The sensor 48 senses a temperature of the heater assembly 34. For example, the sensor 48 may sense a temperature of the heating element 50, or the sensor 48 may sense a temperature of the contact member 42. In this example, the sensor 48 comprises a thermistor. The heating element 50 heats the contact member 42. In this example, the heating element 50 comprises a resistive trace of material (such as copper or stainless steel) that extends across the substrate 51.

The contact member 42 is located on top of the sensor and heating element layer 40 and sits above the top of the recess 47 such that when hair is clamped between the two heater assemblies 32,34, the contact member 42 contacts the hair. The contact member 42 conducts heat from the heating element 50 to the hair in contact with the contact member 42 in order to heat and thereby style the hair.

In addition to the two arms 12,14, the haircare appliance 10 comprises a housing unit 20 that houses a power supply 58 and a control unit 59. In the present example, the housing unit 20 is attached to and moves with the first arm 12. Consequently, as the two arms 12,14 move between the open and closed positions, the second arm 14 moves relative to the housing unit 20.

The power supply 58 supplies electrical power to the other electrical components of the haircare appliance 10, such as the heater assemblies 32,34, and the control unit 59. In the present example, the power supply 58 comprises a battery supplying a DC voltage. In other examples, electrical power may be provided by a mains power supply, and the power supply may comprise a rectifier and a DC-to-DC converter that outputs a DC voltage.

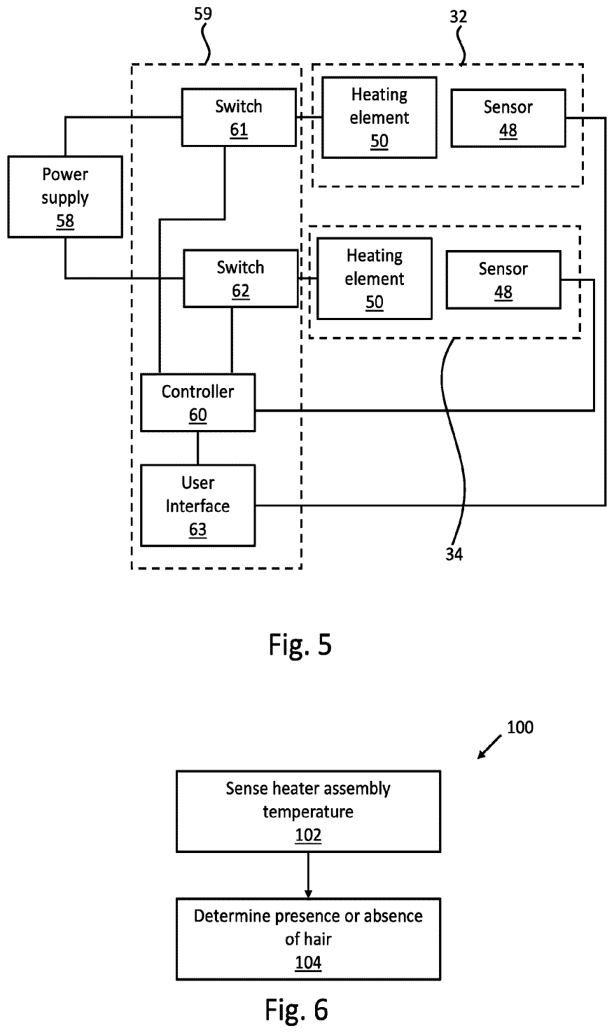

Turning now to FIG. 5, the control unit 59 comprises a pair of switches 61,62, a user interface 63 and a controller 60.

Each of the switches 61,62 is connected between the power supply 58 and the heating element 50 of a respective heater assembly 32,34. Accordingly, when one of the switches 61,62 is closed, electrical power is supplied to the heating element 50 of the corresponding heater assembly 32,34 and the temperature of the heater assembly 32,34 increases. Conversely, when the switch 61,62 is open, electrical power supplied to the heating element is halted and the temperature of the heater assembly 32,34 decreases. Accordingly, the switches 61,62 may be controlled in order to control the temperature of the heater assemblies 32,34.

The user interface 63 may be used to power on and off the haircare appliance 10. Additionally, the user interface 63 may also be used to select a particular heat setting (e.g., low, medium, high) and/or to select a particular mode of operation (e.g., constant temperature or root-to-tip heating).

The controller 60 is connected to the switches 61,62 and the user interface 63. Additionally, the controller 60 is connected to the sensor 48 of each of the heater assemblies 32,34. As a result, the controller 60 is provided with a measure of the temperatures of the two heater assemblies 32,34. The controller 60 is responsible for controlling the operation of haircare appliance 10. In particular, the controller 60 controls the opening and closing of the switches 61,62, and thus the electrical power supplied to the heating elements 50, in response to input data received from the user interface 63 and the sensors 48. For example, the controller 60 may control the switches 61,62 such that the temperature of each of the heater assemblies 32,34, as sensed by the sensors 48, is maintained at a particular setpoint. The setpoint may then be defined by a heating setting or a mode of operation selected by a user using the user interface 63. In examples, the controller 60 may control the duty cycle of the switches 61,62, perhaps using closed loop control, such as PI or PID control.

As will now be described below in more detail, the controller 60 uses the temperatures sensed by the sensors 48 to determine whether hair is present within and/or absent from the haircare appliance 10. This information may then be used by the controller 60 to control the switches 61,62 and thus the temperatures of the heater assemblies 32,34.

FIG. 6 shows an example method 100 for determining the presence or absence of hair in contact with a particular heater assembly. The method 100 may be performed by the controller 60 in order to determine whether hair is or is not in contact with one or each of the heater assemblies 32,34 of the haircare appliance 10.

The method 100 comprises sensing 102 a temperature of the heater assembly. The temperature may be sensed using the sensor 48 of the heater assembly 32,34.

The method 100 further comprises determining 104 the presence or absence of hair in contact with the heater assembly based on the sensed temperature. In examples, the controller 60 may compare the sensed temperature against a threshold or a setpoint and determine the presence or absence of hair in contact with the heater assembly 34 based on the comparison. The presence of hair typically lowers the temperature of the heater assembly for a given electrical input power. Conversely, when hair is removed, the temperature of the heater assembly 34 will increase, again for a given electrical input power. This behaviour can therefore be used to determine the presence or absence of hair by comparing the sensed temperature against a threshold or a setpoint. For example, if the sensed temperature drops below a threshold, or if the difference between the sensed temperature and a desired setpoint is excessive (e.g., the sensed temperature is well below the setpoint), this may suggest that hair is present. Conversely, if the sensed temperature rises above a threshold, or if the difference between the sensed temperature and a desired setpoint is excessive (e.g., if the sensed temperature is well above the setpoint), this may suggest that hair is no longer present.

By implementing the method 100 described above, the controller 60 has an awareness of whether or not hair is present or absent. The controller 60 may then use this awareness to control the switches 61,62 so as to achieve improved styling results. This awareness may also be used by the controller to improve the efficiency or the functionality of the haircare appliance 10. For example, the controller 60 may control the switches 61,62 such that temperature of each of the heater assemblies is increased when hair is present and decreased when hair is absent.

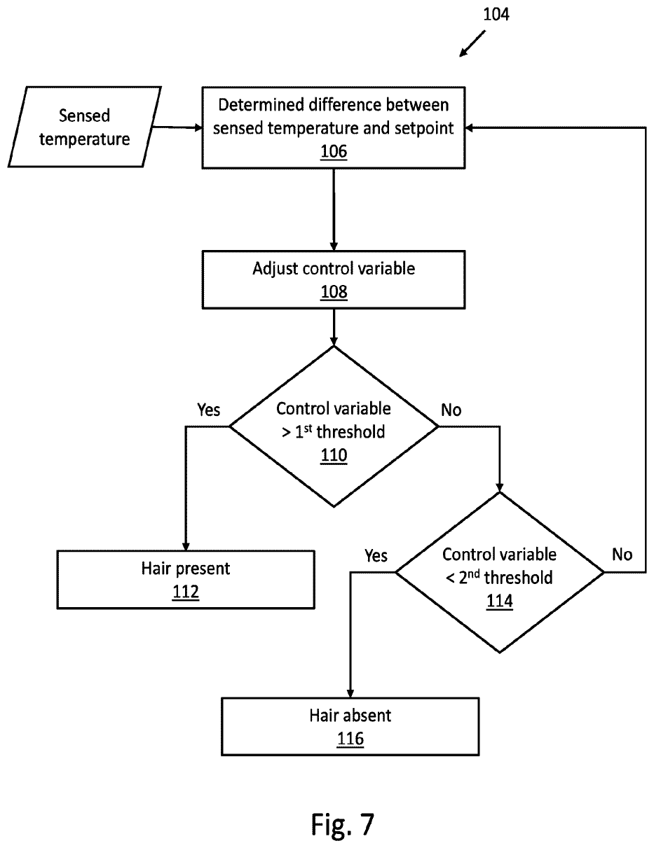

FIG. 7 shows an example method 104 for determining the presence or absence of hair based on the sensed temperature. The method 104 comprises receiving a sensed temperature and determining 106 the difference between the sensed temperature and a setpoint. Then the method 104 comprises adjusting 108 a control variable based on the difference value. The control variable is used to control the supply of electrical power to the heating element of the heater assembly. In this example, the control variable is the duty cycle of the switch 61,62 for that heater assembly, and is defined as a function of the difference value. In alternative examples, the control variable may be defined as a function of the sensed temperature. The method 104 then comprises comparing 110 the control variable to a first threshold. In the event that the control variable is greater than the first threshold, the presence of hair is determined 112. In the event that the control variable does not exceed the first threshold, the control variable is compared 114 to a second threshold. In the event that the control variable is less than the second threshold, the absence of hair is determined 116. In the event that the control variable is not less than the second threshold, the method returns to the first determining step 106. As a result, the method 104 may be used to determine the presence (i.e. the arrival) and subsequent absence (i.e. the departure) of hair.

An implementation of the method 104 of FIG. 7 will now be provided by way of example. The heater assembly may be heated to a setpoint of 200° C. Upon inserting hair into the haircare appliance, the heater assembly may experience a significant drop in temperature. In response, the control variable is increased so as to supply a higher electrical power to the heater assembly. Since the decrease in the temperature of the heater assembly is significant, the resulting increase in the control variable causes the control variable to exceed the first threshold. As a result, hair is determined to be present. When the hair is subsequently removed from the haircare appliance, the temperature of the heater assembly increases. The control variable is therefore decreased so as to supply a lower electrical power to the heater assembly. Owing to the magnitude of the increase in the temperature of the heater assembly, the resulting decrease in the control variable causes the control variable to drop below the second threshold. As a result, hair is determined to be absent.

As discussed in more detail below, the method of 104 may employ multiple setpoints and/or setpoints that vary during operation of the haircare appliance 10. This may have the advantage of enabling dynamic or variable temperature control. For example, the haircare appliance may employ a lower temperature at the roots of the hair and gradually increase the temperature as the haircare appliance is moved towards the tips of the hair. This root-to-tip heating may reduce damage to the hair by using a lower temperature at the roots where the hair is younger, and a higher temperature at the tips where the hair is older.

In the method 104 described above and illustrated in FIG. 7, the presence or absence of hair is determined by comparing a control variable against a threshold. The control variable is defined as a function of the sensed temperature, and more particularly as a function of a difference value between the sensed temperature and a setpoint. In other examples, the presence or absence of hair may be determined by comparing a different parameter against a threshold, where that parameter is defined as a function of the sensed temperature. For example, the parameter may be the sensed temperature, a difference value between the sensed temperature and a setpoint, or the magnitude of electrical power supplied to the heating element.

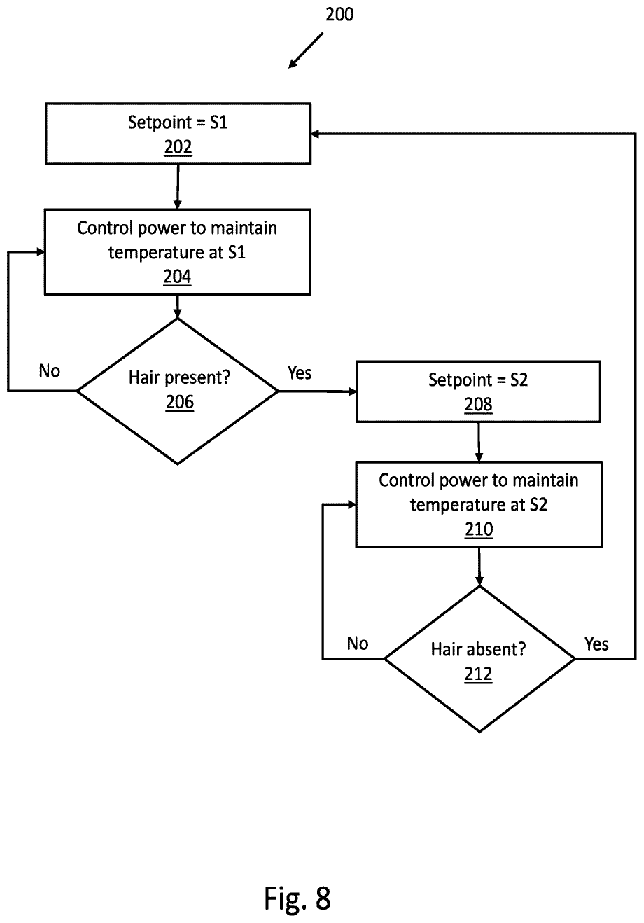

The determination of the presence or absence of hair in contact with the heater assembly may be used to control the power to the heating element. By way of example, FIG. 8 shows an example method 200 of using the determination to implement dynamic or variable temperature control of the heating element.

The method 200 comprises setting 202 the setpoint to a first setpoint value, S1. The first setpoint value may be, for example, 150° C. Then the method 200 comprises controlling the supply of electrical power to the heating element to maintain the temperature of the heating element at the first setpoint. Next the method 200 comprises determining 206 if hair is present. If the presence of hair is not determined, the method 200 returns to controlling the supply of electrical power to the heating element to maintain the temperature of the heating element at the first setpoint. If, on the other hand, the presence of hair is determined, the method 200 comprises increasing 208 the setpoint from the first setpoint value to a second setpoint value, S2. The second setpoint value may be, for example, 200° C. The method 200 then comprises controlling 210 the supply of electrical power to the heating element to maintain the temperature of the heating element at the second setpoint value. Then the method 200 comprises determining 212 if hair is absent. If the absence of hair is not determined, the method 200 returns to controlling 210 the supply of electrical power to the heating element to maintain the temperature of the heating element at the second setpoint. If, on the other hand, the absence of hair is determined, the method comprises decreasing 202 the setpoint to the first setpoint value, and the method 200 repeats. Thereby, the heater assembly 34 may respond to the arrival of hair by operating at a higher temperature (i.e., the second setpoint value) to style the hair, and respond to the subsequent departure of the hair by operating at a lower temperature (i.e., the first setpoint value) to reduce the energy consumption of the heater assembly.

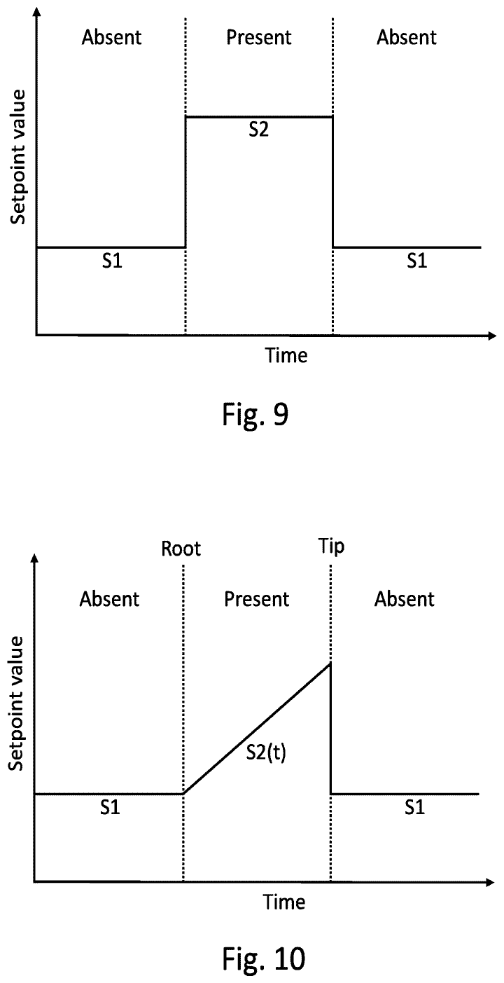

In the example method 200 of FIG. 8, the second setpoint value is constant and does not vary with time. FIG. 9 illustrates the behaviour of the setpoint value with time when employing the method 200 described above. In other examples, the method 200 may comprise varying the second setpoint value with time. FIG. 10 shows an example profile of the setpoint value, in which the second setpoint value varies linearly with time. More particularly, the second setpoint value increases from a minimum value equal to the first setpoint value (e.g., 150° C.) to a maximum value (e.g., 200° C.). Thereby, the method 200 may be used to implement the root-to-tip heating profile discussed previously. Although the second setpoint value of FIG. 10 varies linearly with time, in other examples the second setpoint value could vary non-linearly with time.

The rate at which the second setpoint value varies with time may be a predetermined value. Alternatively, the rate may be based on a user setting (e.g., indication of hair length), or the length of time taken for a tress of hair to pass through the haircare appliance. In this way, the rate may be defined such that better control may be achieved of the final temperature at the end of the pass. The length of time taken for a tress of hair to pass through the haircare appliance may be determined from the duration between determining the presence of hair and determining the subsequent absence of hair. For example, using the steps outlined above, the method may comprise determining the presence (i.e., the arrival) of hair, determining the subsequent absence (i.e., the departure) of hair, and then determining a rate of change of the second setpoint value based on the duration between these two events. By using a rate based on the determined duration, the controller 60 of the haircare appliance 10 may tailor the root-to-tip heating to a specific user (e.g., short hair vs long hair) or user behaviour (e.g., quick passes vs slow passes) to achieve a desired temperature increase between root and tip. As noted above, this root-to-tip heating may reduce damage to the hair by using a lower temperature at the root where the hair is younger, and a higher temperature at the tip where the hair is older.

In addition to the that described above, the controller 60 may use the determination of hair presence and absence to provide additional functionality to the haircare appliance 10. For example, the controller 60 may provide feedback to the user. In one example, the control unit 59 may comprise a feedback device, such as audible, visual or haptic feedback device, and the controller 60 may provide feedback via the device based on the presence, absence or the duration between the presence and absence of hair. For example, the duration may be used to provide feedback on the speed of the haircare appliance 10 along a tress of hair. For example, an alert may be provided if the speed of the haircare appliance is too fast or too slow.

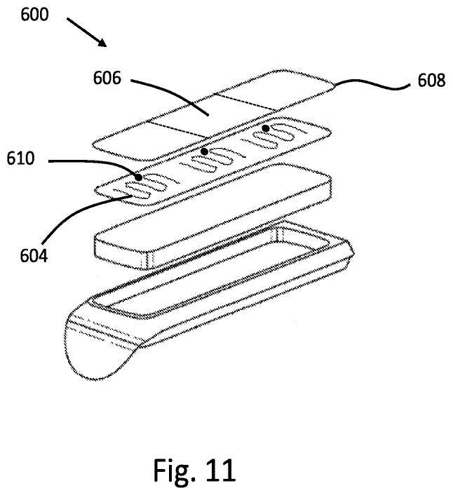

In the example heater assembly 34 described in relation to FIG. 4, the heater assembly 34 comprises a single heating element 50 that heats the contact member 42 and a single sensor that senses the temperature of the contact member 42. However, in alternative examples, the heater assembly may comprise a plurality of heating elements and/or a plurality of sensors. By way of example, FIG. 11 shows a heater assembly 600 that comprises three heating elements 604 and three sensors 610. Each of the heating elements 604 is located underneath a respective zone 606 of the contact member 608 such that the contact member comprises three zones 606, each of which may be heated by its respective heating element 604. Each of the sensors 610 is likewise located underneath a different zone 606 of the contact member 608 such that a temperature of each of the zones 606 may be sensed. In all other respects, the heater assembly 600 of FIG. 11 is unchanged from that described above and illustrated in FIG. 4. When employed in the haircare appliance 10, the control unit 59 comprises a switch for each of the heating elements 604. Accordingly, in this particular example, the control unit 59 would comprise a total of six switches, three for each of the heater assemblies.

When the heater assembly 600 of FIG. 11 is employed in the haircare appliance 10, the controller 60 may determine the presence or absence of hair in contact with each of the zones independently. That is to say, the controller 60 may determine for which of the zones hair is absent and for which of the zones 606 hair is present. The controller 60 is then able to control the temperature of each of the heating elements 604, and thereby each of the zones 606, independently.

With the heater assembly illustrated in FIG. 11, the controller 60 may implement methods which are able to respond to uneven distributions of hair over the heater assembly 600. As an example, the controller 60 may implement a method that comprises controlling the supply of electrical power to each of the heating elements 604 to maintain the temperature of each of the heating elements 604 at a first setpoint value. For example, the controller 60 may control the duty cycle of each of the switches to control the temperature of each heating element 604 and thus each zone 606 of the contact member 608. Next, the method may comprise determining the presence or absence of hair in contact with each of the zones 606 of the contact member 608 based on the sensed temperatures. The controller 60 may then implement the method of FIG. 7 and/or FIG. 8 for each of the zones 606 of the heater assembly 600. As a result, the temperature of only those zones in contact with hair is increased and those zones that are not in contact with hair operate at a lower temperature to thereby reduce energy consumption and improve the efficiency and longevity of the haircare appliance. Additionally, those zones that are not increased in temperature may act as heat sinks for adjacent zone(s) that are increased in temperature. This may then prevent hair damage caused by localised overheating that may result from incomplete hair coverage of a zone.

In some examples, upon determining the presence of hair in contact with one or more of the zones of the contact member, the temperature or the setpoint of those heating elements which heat a zone for which the absence of hair is determined may be decreased. So, for example, when employing the method of FIG. 8, the setpoint of those zones not in contact with hair may be decreased from the first setpoint value to a third, lower setpoint value. The third setpoint value may be between 40° C. and 60° C. degrees lower than the first setpoint value. This may provide a good balance between the competing needs of a sufficiently low temperature to significantly reduce the energy consumption of the heating elements that are not required and a sufficiently high temperature to ensure a good response time upon subsequent determination of hair in contact with the zones. In some examples, no electrical power may be supplied to those heating elements of zones that are not in contact with hair, i.e., the controller 60 may open the switches to those heating elements. This may result in a significant reduction in the energy consumption of the heater assembly 600 but may impact its thermal responsiveness (i.e., its ability to respond quickly to changes in temperature demand). However, by ensuring that the thermal mass of the heater assembly 600 is relatively low, the potential impact on thermal responsiveness may be mitigated.

Whilst particular examples and embodiments have thus far been described, it should be understood that these are illustrative only and that various modifications may be made without departing from the scope of the invention as defined by the claims.

1. A haircare appliance comprising:
a heater assembly comprising a heating element and a sensor to sense a temperature of the heater assembly; and
a controller configured to determine the presence or absence of hair in contact with the heater assembly based on the sensed temperature.

2. The haircare appliance of claim 1, wherein the controller is configured to:
compare the sensed temperature against a setpoint; and
determine the presence or absence of hair in contact with the heater assembly based on the comparison.

3. The haircare appliance of claim 1, wherein the controller is configured to control a supply of electrical power to the heating element based on the determination.

4. The haircare appliance of claim 3, wherein the controller is configured to increase the supply of electrical power to the heating element to increase the temperature of the heating element in response to determining the presence of hair in contact with the heater assembly or to decrease the supply of electrical power to the heating element to decrease the temperature of the heating element in response to determining the absence of hair in contact with the heater assembly.

5. The haircare appliance of claim 4, wherein the controller is configured to:
control the supply of electrical power to the heating element to maintain the temperature of the heating element at a setpoint; and
increase the setpoint in response to determining the presence of hair in contact with the heater assembly or decrease the setpoint in response to determining the absence of hair in contact with the heater assembly.

6. The haircare appliance of claim 5, wherein the controller is configured to:
increase the setpoint from a first value to a second value in response to determining the presence of hair in contact with the heater assembly; and
decrease the setpoint from the second value to the first value in response to determining the absence of hair in contact with the heater assembly.

7. The haircare appliance of claim 1, wherein:
the heater assembly comprises:
a contact member having a plurality of zones;
a plurality of heating elements, each heating element for heating a respective zone of the contact member; and
a plurality of sensors, each sensor for sensing a temperature of a respective zone of the contact member, and
the controller is configured to:
determine the presence or absence of hair in contact with each of the zones of the contact member based on the sensed temperatures; and
control a supply of electrical power to each of the heating elements based on the determination.

8. The haircare appliance of claim 7, wherein, in response to determining the presence of hair in contact with one or more of the zones of the contact member, the controller is configured to increase the supply of electrical power to only those heating elements of the zones for which the presence of hair is determined.

9. The haircare appliance of claim 8, wherein the controller is configured to:
control the supply of electrical power to each of the heating elements to maintain the temperature of each of the heating elements at a respective setpoint; and
increase the setpoint for only those heating elements of the zones for which the presence of hair is determined.

10. The haircare appliance of claim 9, wherein, for only those heating elements of the zones for which the presence of hair is determined, the controller is configured to:
increase the setpoint from a first value to a second value; and
decrease the setpoint from the second value to the first value for only those heating elements of the zones for which the subsequent absence of hair is determined.

11. The haircare of claim 8, wherein in response to determining the presence of hair in contact with one or more of the zones of the contact member, the controller is configured to decrease or maintain the supply of electrical power to those heating elements of the zones for which the absence of hair is determined.

12. The haircare appliance of claim 11, wherein the controller is configured to:
control the supply of electrical power to each of the heating elements to maintain the temperature of each of the heating elements at a respective setpoint; and
decrease the setpoint for each of those heating elements which heat a zone for which the absence of hair is determined.

13. The haircare appliance of claim 1, wherein the controller is configured to:
determine the presence and the absence of hair in contact with the heater assembly based on the sensed temperature; and
determine a duration between determining the presence of hair and determining the subsequent absence of hair.

14. The haircare appliance of claim 13, wherein in response to determining the presence of hair in contact with the heater assembly, the controller is configured to increase the supply of electrical power to the heating element to increase the temperature of the heating element at a rate based on the determined duration.

15. The haircare appliance of claim 1, wherein the controller is configured to compare a parameter against a threshold, and to determine the presence or absence of hair in contact with the heater assembly based on the comparison, and wherein the parameter is one of:
the sensed temperature;
a difference between the sensed temperature and a setpoint;
a magnitude of electrical power supplied to the heating element; and
a control variable for use in controlling a supply of electrical power to the heating element, wherein the control variable varies as a function of the sensed temperature.

16. The haircare appliance of claim 15, wherein the controller is configured to:
determine the presence of hair in contact with the heater assembly based on the parameter traverses a first threshold; and
determine the subsequent absence of hair in contact with the heater assembly based on the parameter traversing a second threshold.

17. method comprising:
sensing a temperature of a heater assembly of a haircare appliance; and
determining the presence or absence of hair in contact with the heater assembly based on the sensed temperature.
